(19) United States
(12) Patent Application Publication
(10) Pub. No.: US 2008/0201745 A1
(43) Pub. Date: Aug. 21, 2008

(54) CONTROL CIRCUIT OF DISPLAY DEVICE HAVING PROGRAM SEARCH FUNCTION AND METHOD FOR CONTROLLING DISPLAY DEVICE TO RECEIVE PROGRAM INFORMATION OF TV PROGRAMS AND SELECTING PROGRAMS

(76) Inventor: Pin-Hsiang Chien, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/016,215

(22) Filed: Jan. 18, 2008

(30) Foreign Application Priority Data
Feb. 16, 2007 (TW) 096105999

(51) Int. Cl. H04N 5/445

(52) U.S. Cl. 725/53; 725/39

(57) ABSTRACT

The present invention provides a control circuit of a program search display device and a method for controlling a display device to receive program information of TV programs and select programs. The method comprises: (a) receiving a TV signal; (b) processing the TV signal to generate program information; (c) storing the program information; (d) receiving an input data; (e) reading the program information and comparing the program information with the input data to generate a program comparison result; and (f) displaying the program comparison result.

### BACKGROUND OF INVENTION

1. Field of the Invention

The present invention relates to a control circuit of a display device and a method for selecting TV programs, especially to a control circuit of a display device having a program search function and a method for controlling a display device to receive program information of TV programs and selecting programs.

2. Description of the Prior Art

As the vigorous development of the digital television, more and more various relevant services are provided. For example, for the digital TV, there are additional channels for providing program information of TV programs, such as program schedules, broadcasting channels, program introductions, staff lists of actors or players, and program ratings. Program information of the above type is referred to as Electronic Program Guide (EPG). Before EPG appeared, viewers had to look up in the newspaper, or TV program schedules provided by cable TV companies, or through Internet for program schedules of numerous TV stations. Now through EPG, viewers can search for programs directly on the TV screen, and get program schedules of TV stations for the upcoming one or two weeks, together with program introduction, via the remote controller. Thereby it's more convenient for viewers to find desired programs.

According to US patent publication number US 20030074663, there provides a convenient interface and a easy method for searching for TV programs through EPG, wherein a control panel is displayed on the display device, and viewers can select broadcasting times and channels by making use of buttons on the control panel to get program information of some matching program and thereby determine whether to watch that program. However, when TV stations are so many that searching every program and every channel would consume much time and become troublesome, it's necessary to provide more convenient methods for viewers to find desired programs more quickly.

### SUMMARY OF INVENTION

It is therefore a primary objective of the claimed invention to provide a control circuit of a display device having a program search function, and a method for control a display device to receive program information of TV programs and select programs.

According to an embodiment of the claimed invention, a control circuit of a display device having a program search function is disclosed. The control circuit comprises a tuner, a demodulator, a data analyzing unit, a storage unit, a receiving unit, and a controller. The tuner is for receiving a TV signal. The demodulator coupled to the tuner is for demodulating the TV signal to generate a demodulated signal. The data analyzing unit coupled to the demodulator is for processing a data component of the demodulated signal to generate program information. The storage unit coupled to the data analyzing unit is for storing the program information. The receiving unit is for receiving an input data. The controller is coupled to the tuner, the storage unit and the receiving unit and is for reading the program information from the storage unit and comparing the program information with the input data.

According to another embodiment of the claimed invention, a control circuit of a display device having a program search function is disclosed. The control circuit comprises a controller, a first tuner, a second tuner, a demodulator, a data analyzing unit, a storage unit, a video decoder, and an image processing unit. The first tuner coupled to the controller is for receiving a first TV signal. The second tuner coupled to the controller is for receiving a second TV signal. The demodulator coupled to the first tuner and the second tuner is for demodulating the first TV signal and the second TV signal to generate respectively a first demodulated signal and a second demodulated signal. The data analyzing unit coupled to the demodulator is for processing a data component of the first demodulating signal to generate program information. The storage unit coupled to the data analyzing unit is for storing the program information. The video decoder coupled to the demodulator is for decoding an image component of the second demodulating signal to generate a decoded image signal. The image processing unit coupled to the video decoder and the controller is for processing the decoded image signal to generate a TV program image signal.

According to still another embodiment of the claimed invention, a method for controlling a display device to receive program information of TV programs and select programs is disclosed. The method comprises: (a) receiving a TV signal; (b) processing the TV signal to generate program information; (c) storing the program information; (d) receiving an input data; (e) reading the program information and comparing the program information with the input data to generate a program comparison result; and (f) displaying the program comparison result.

According to still another embodiment of the claimed invention, a method for controlling a display device to receive program information of TV programs and select programs is disclosed. The method comprises: (a) receiving a first TV signal with a first tuner; (b) processing the first TV signal to generate program information; (c) receiving a second TV signal with a second tuner; (d) processing the second TV signal to generate a TV program image signal; (e) storing the program information; (f) receiving an input data; and (g) reading the program information and comparing the program information with the input data.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a control circuit of a program search display device according to a first embodiment of the claimed invention.

FIG. 2 is the program information guide picture according to the first embodiment of the claimed invention.

FIG. 3 is a diagram of the display device displaying the TV program image and the program information guide picture simultaneously.

FIG. 4 is a diagram of the display device displaying only the program information guide picture.

FIG. 5 is a diagram of a control circuit of a program search display device according to a second embodiment of the claimed invention.

FIG. 6 is a flow chart of the method for performing the scanning procedures after entering the power-on mode according to a preferred embodiment of the claimed invention.

FIG. 7 is a flow chart of the method for performing the scanning procedures under the standby mode according to another preferred embodiment of the claimed invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include” but not limited to. Also, the term “couple” is intended to mean either an indirect or direct electrical connection. Accordingly, if one device is coupled to another device, that connection may be through a direct electrical connection, or through an indirect electrical connection via other devices and connections.

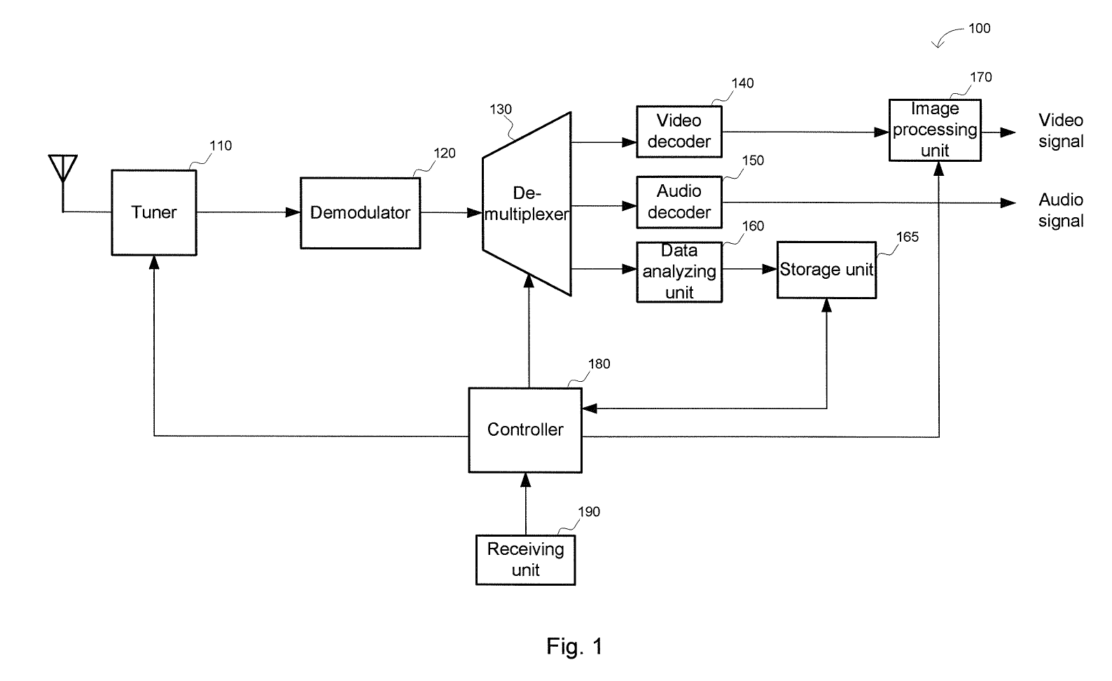

FIG. 1 shows a control circuit of a display device having a program search function according to a first embodiment of the claimed invention. The control circuit 100 comprises a tuner 110, a demodulator 120, a de-multiplexer 130, a video decoder 140, an image processing unit 170, an audio decoder 150, a data analyzing unit 160, a storage unit 165, a controller 180, and a receiving unit 190. The tuner 110 is for receiving a TV signal in analog or digital format. For conventional analog TV signals, there used to be no overall program information offered to the viewers. However, during the period when TV signals are gradually turning into digital format, analog and digital TV signal may coexist, and therefore one single TV station may provide both analog TV signals and digital TV signals at the same time. In addition to its own program information, the digital TV signal is also capable of transmitting program information of the analog TV signal, and thereby viewers can still get program information of analog TV programs.

The demodulator 120 which is coupled to the tuner 110 is for demodulating the TV signal into a demodulated signal based on the transmission standard of the signal. For example, demodulating methods of terrestrial broadcasting for U.S. and European standards are different, and hence it's necessary to use a corresponding demodulator 120. Then, the de-multiplexer 130 retrieves a video component, an audio component, a data component of the TV signal, and outputs each component according to the property thereof. For example, the image component is outputted to the video decoder 140, and the video decoder 140 decodes the video component to generate a decoded video signal. The image processing unit 170 processes the decoded video signal by scaling, interpolation, brightness adjustment, noise reduction, sharpening, and etc. to generate a TV program image signal which can be displayed on display devices such as a liquid crystal display (LCD) and a plasma display panel (PDP). The audio decoder 150 processes the audio component to generate an audio signal. The data analyzing unit 160 processes the data component to generate program information. The storage unit 165 coupled to the data analyzing unit 160 is for storing the program information.

The controller 180 is coupled to the tuner 110, the de-multiplexer 130, the storage unit 165, the image processing unit 170, and the receiving unit 190. Viewers can send commands to the controller 180 through the receiving unit 190. For example, if viewers send out a channel switching signal, then the controller 180 controls the tuner 110 to switch to the physical channel corresponding to a selected target program; meanwhile, the controller 180 controls the de-multiplexer 130 to select the target program. When the viewer sends out a program information browsing signal, then the controller 180 reads the program information from the storage unit 165 and controls the image processing unit 170 to output a program information browsing picture to a display unit (not shown). Thus viewers can browse the program information directly through the display unit.

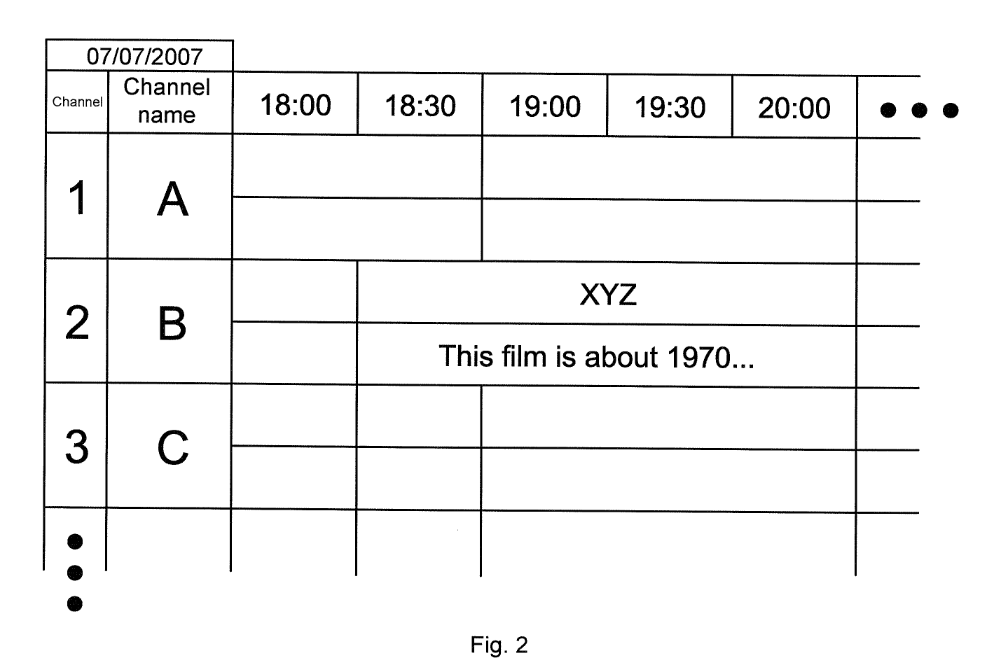

FIG. 2 shows the program information browsing picture according to the first embodiment of the claimed invention. The content of the program information browsing picture contains the date, the channel, and the channel name. Viewers can look up program information in light of preferred channels and specific dates. The program information browsing picture uses a half-hour time increment. If the length of a program is over a half hour, its name is shown across at least two time intervals. In addition to the program name, the program information browsing picture shows a summary of the program. For example, the TV station B of channel 2 broadcasts a movie “XYZ” (18:30-20:30), and the summary of the movie shown below the movie name contains an introduction to the story, an introduction of main characters, awards & records, and the box office etc., so as to give viewers a brief outline of the movie. For Program and System Information Protocol (PSIP) for the U.S. standard, this kind of information is referred to as Event Information Table (EIT). Moreover, PSIP further contains Extended Text Table (ETT) which is for more detail on the program.

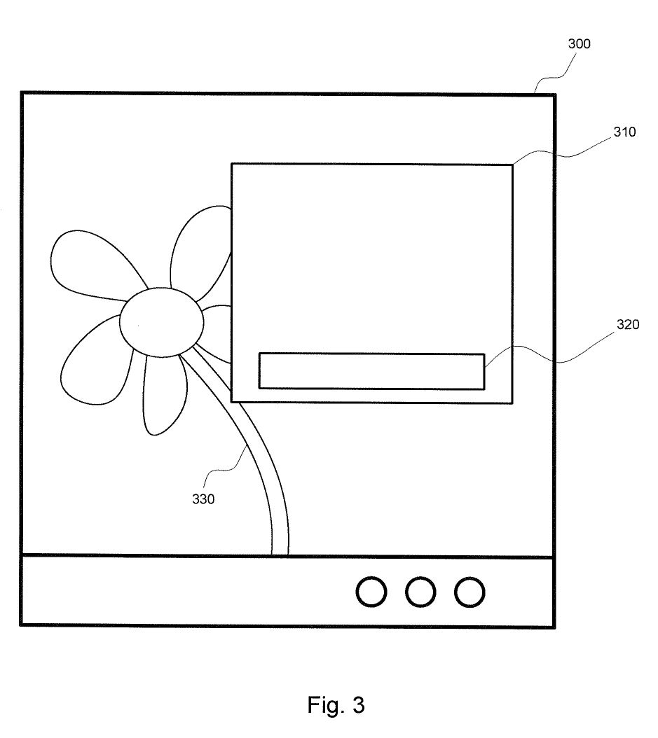

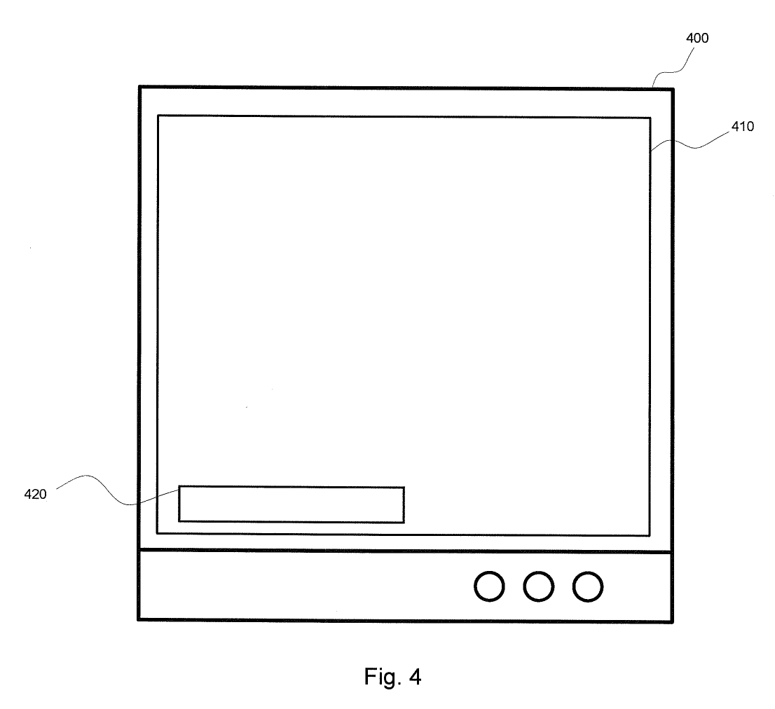

A preferred embodiment of the receiving unit 190 can be a control panel of a display device (e.g. a flat panel display) or a receiver corresponding to a remote controller. The TV program image signal and the program information browsing picture can be outputted simultaneously by the image processing unit 170. The program information browsing picture can be displayed on the display unit by means of on-screen display (OSD) as shown in FIG. 3, namely, an image picture 330 of a TV program and the program information browsing picture 310 are displayed simultaneously on the monitor of the display device 300. Alternatively, when outputting the program information browsing picture, the image processing unit 170 ceases outputting the TV program image signal as shown in FIG. 4, namely, the controller 180 controls the image processing unit 170 to output the program information browsing picture 410 only, and cease outputting the TV program image signal. In that case, the program information browsing picture 410 is displayed in full screen on the monitor of the display device 400, so that viewers can look up program information more conveniently.

However, due to numerous channels and programs, it's not easy to find desired programs among so much program information. Hence the present invention provides a search function to let viewers find desired programs quickly. When viewers perform the search function, the receiving unit 190 receives a channel search signal and informs the controller 180. Then, the controller 180 controls the image processing unit 170 to show an input window 320 (420) on the program information browsing picture 310 (410) as shown in FIG. 3 (FIG. 4). Viewers can input a key word into the input window 320 (420) through a remote controller or the control panel of the display device 300 (400), and the key words (namely an input data) are received by the receiving unit 190 and subsequently sent to the controller 180. Next, the controller 180 reads the program information from the storage unit 165 and compares the input data with the program information to generate a program comparison result. Wherein the controller 180 compares the input data with all content included in the program information such as EIT and ETT of PSIP for the U.S. standard, the date, the channel, the channel name, and the program name etc. Compared to PSIP for the U.S. standard, the broadcasting system for the European standard uses EPG to offer similar service, and in that case the controller 180 searches and compares channels and program information in a similar way.

After comparing the program information and the input data, the controller 180 sends the program comparison result to the image processing unit 170, and then the program comparison result is shown on the program information browsing picture 310 (410). The program comparison result lists exact or partial match results for the keyword, and viewers can move the cursor to select a target program they are interested in. Once the target program is selected, the controller 180 determines whether the target program is being broadcasted (on air) according to the broadcasting time of the target program. If the target program is on air, the controller 180 controls the tuner 110 to switch to the physical channel corresponding to the target program; meanwhile, the controller 180 controls the de-multiplexer 130 to select the target program. Next, the image processing unit 170 outputs a TV program image signal corresponding to the target program. If the target program is not on air, the controller 180 controls the image processing unit 170 to show an alarm signal on the program information browsing picture, so as to inform viewers that the target program is not on air; and further, viewers are asked whether to set the reminding function. If viewers set the reminding function, then the controller 180 generates reminder information and stores the reminder information in the storage unit 165. The controller 180 will check the reminder information periodically and control the image processing unit 170 according to the setting time of the reminder information to output a reminder picture which informs viewer that the target program will soon be broadcasted or is being broadcasted. When the reminder picture is displayed through OSD, the display device can display the TV program image and the reminder picture simultaneously.

For the embodiment shown in FIG. 1, if it's desired to collect and store program information of all programs in the storage unit 165, the controller 180 will have to control the tuner 110 and the de-multiplexer 130 to scan every channel, so as to obtain program information of all programs. The above scanning procedures can be performed after the display device enters a power-on mode, and in that case the tuner 110 switches channel continuously under the control of the controller 180, causing the display device to be not able to show a stable image. As a result, the controller 180 can control the image processing unit 170 to output a waiting picture to inform viewers that the display device is performing the scanning procedures. After the scanning procedures are completed and program information of all programs is stored in the storage unit 165, the controller 180 controls the image processing unit 170 to cease outputting the waiting picture and output the normal TV image frame instead. However, the scanning procedures usually consume a great deal of time. Unless the scanning procedures are interrupted, viewers cannot watch a stable image of TV programs until the scanning procedures are completed. To overcome this flaw, it's feasible to make use of software control to make the controller 180 automatically control the tuner 110 and the de-multiplexer 130 to perform the scanning procedures when the display device is under the standby mode (the display device connected to the power source but not powered on), so as to collect and store program information of all programs in the storage unit 165. When the display device is under the standby mode, the monitor of the display device is turned off, and viewers can send a power-on signal to the controller 180 through the receiving unit 190. Once the controller 180 receives the power-on signal, the controller 180 controls the display device to enter the power-on mode from the standby mode, and thereby the monitor turns on. Therefore, if the tuner 110 and the de-multiplexer 130 complete the scanning procedures and generate program information before the display device enters the power-on mode, then viewers can watch a stable image of TV programs, look up program information, and search for desired programs right after powering on the display device without waiting for the completion of the scanning procedures because at this time the complete program information of all programs has been stored in the storage unit 165.

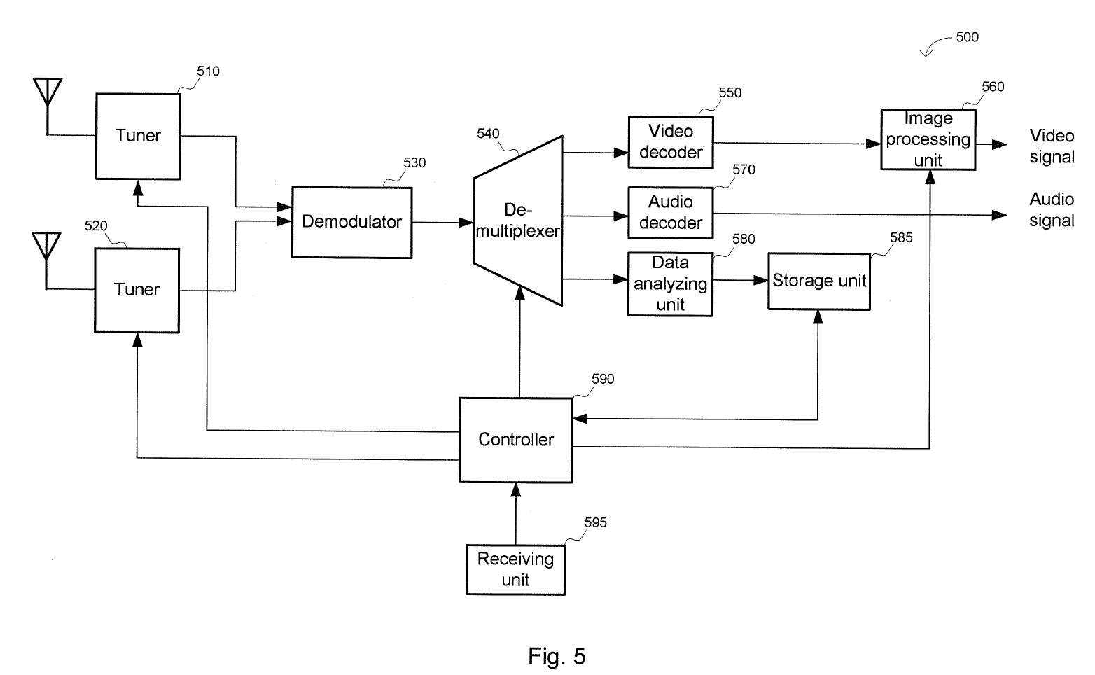

In addition to performing the scanning procedures to update program information under the standby mode, it is practical to utilize a second tuner to provide aid for scanning procedures. FIG. 5 shows a control circuit of a display device having a program search function according to a second embodiment of the claimed invention. The control circuit 500 comprises two tuners 510 and 520, a demodulator 530, a de-multiplexer 540, a video decoder 550, an image processing unit 560, an audio decoder 570, a data analyzing unit 580, a storage unit 585, a controller 590, and a receiving unit 595. In FIG. 5, the elements designated by the same names as those elements shown in FIG. 1 have similar or identical functions. In the second embodiment, the controller 590 controls one of the tuner 510 and the tuner 520 to perform the scanning procedures to collect program information, and controls the other tuner to switch to the physical channel corresponding to a selected target program, so as to receive the TV signal of the target program selected by viewers. For example, the controller 590 controls the tuner 510 to receive a first TV signal, and the demodulator 530 demodulates the first TV signal into a first demodulated signal. Then, the data analyzing unit 580 processes a data component of the first demodulated signal to generate program information; i.e., the controller 590 controls the tuner 510 to perform the scanning procedures to collect program information. On the other hand, the controller 590 controls the tuner 520 to receive a second TV signal, the demodulator 530 demodulates the second TV signal into a second demodulated signal, and the video decoder 550 decodes an image component of the second demodulated signal to generate a decoded image signal. Then, the image processing unit 560 processes the decoded image signal to generate a TV program image signal; i.e., the controller 580 controls the tuner 520 to receive the second TV signal corresponding to the target program selected by viewers. Consequently, the scanning procedures and the reception of TV program image signals can be performed simultaneously, and thereby a viewer will not be interfered when he/she is watching the program.

The demodulator 530 coupled to the tuners 510 and 520 is for demodulating the TV signals received by the tuners 510 and 520. The demodulated signals are processed by the de-multiplexer 540, and the controller 590 controls the de-multiplexer 540 to select programs according to the commands from viewers. The de-multiplexer 540 separates an image component, an audio component, a data component out of the demodulating signal. The video decoder 550 and the image processing unit 560 process the image component to generate a TV image signal. The video decoder 550 and the image processing unit 560 have identical or similar functions as the video decoder 140 and the image processing unit 170 in the first embodiment, respectively. The audio decoder 570 processes the audio component to generate an audio signal. The data analyzing unit 580 processes the data component to generate program information to be stored in the storage unit 585. The receiving unit 595 coupled to the controller 590 is similar to the receiving unit 190 in FIG. 1, and can be implemented by a control panel of a display device or a receiver corresponding to a remote controller. The receiving unit 595 is for receiving the commands or the input data from viewers. The controller 590 is coupled to the storage unit 585 and the image processing unit 560 and is able to read program information stored in the storage unit 585 and control the image processing unit 560 to show program information by means of OSD on the display unit of the display device. The controller 590 is also able to compare the program information with the input data received by the receiving unit 595, and send the program comparison result to the image processing unit 560, and then the program comparison result is shown through the display unit of the display device.

The circuit configuration shown in FIG. 5 can be applied to the display device supporting picture-out-picture (POP) or picture-in-picture (PIP), and two TV programs of different channels can be watched simultaneously through the control of the controller 590. In this situation, viewers may want to watch two different channels simultaneously right after powering on the display device, thus, the controller 590 cannot use one of the tuners 510 and 520 to perform the scanning procedures to collect program information. If it is necessary to perform scanning procedures, the controller 590 controls one of the two tuners to switch to the corresponding channel to receive the target program selected by viewers, and control the other tuner to perform the scanning procedures. In this case, viewers can watch only one program, and only after the scanning procedures are completed can viewers watch two different channels simultaneously. To improve this, it's feasible to make use of software control to make the controller 590 control one or both of the tuners 510 and 520 to perform the scanning procedures when the display device is under the standby mode. Besides, using both of the tuners 510 and 520 to perform the scanning procedures take less time to collect program information.

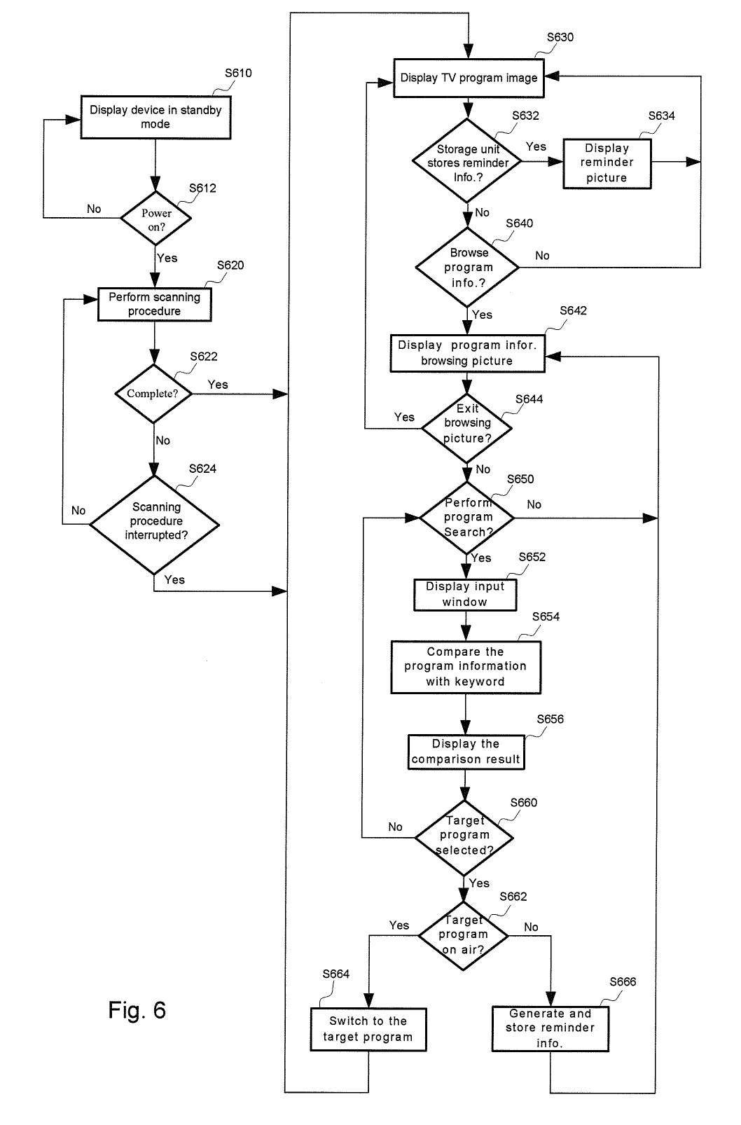

FIG. 6 illustrates a flow chart of the method for performing the scanning procedures after the display device enters the power-on mode. In the beginning, the display device is under the standby mode (S610). Next, a step of determining whether to enter the power-on mode is performed (S612). Then, a step of performing the scanning procedures (S620) after the display device enters the power-on mode is performed. Next, a step of determining whether the scanning procedures are complete is performed (S622). If the scanning procedures are complete, a step of displaying the TV program image is performed (S630). If the scanning procedures are not complete, a step of determining whether the scanning procedures are interrupted is performed (S624). If the scanning procedures are not interrupted, the procedure goes back to S620. If the scanning procedures are interrupted, the procedure goes to S630.

Next, a step of determining whether the storage unit stores reminder information is performed (S632). If the storage unit stores a reminder information, a step of displaying a reminder picture to remind viewers (S634) is performed, and then the procedure goes back to S630; if not, a step of determining whether a program information browsing signal is received is performed (S640). If a program information browsing signal is not received, the procedure goes back to S630; if yes, a step of displaying a program information browsing picture is performed (S642). Then, if viewers exit the program information browsing picture (S644) the procedure goes back to S630. If viewers do not exit the program information browsing picture (S644), a step of determining whether to search programs is performed (S650). If not, the procedure goes back to S642; if yes, steps of showing an input window on the program information browsing picture (S652) and comparing the program information with a keyword inputted by viewers through the input window (S654), and then displaying the program comparison result (S656) are performed. Next, a step of determining whether a target program is selected is performed (S660). If no target program is selected, the procedure goes back to S650; if yes, a step of determining whether the target program is being broadcasted (S662). If the target is being broadcasted, a step of switching to the target program (S664) is performed, and then the procedure goes back to S630; if not, a step of generating and storing reminder information in the storage unit (S666) is performed, and the procedure goes back to S642. In the second embodiment shown in FIG. 5, the controller 590 controls one of the tuners 510 and 520 to switch to the physical channel corresponding to the target program, and controls the de-multiplexer 540 to select the target program so as to switch to the target program (S664).

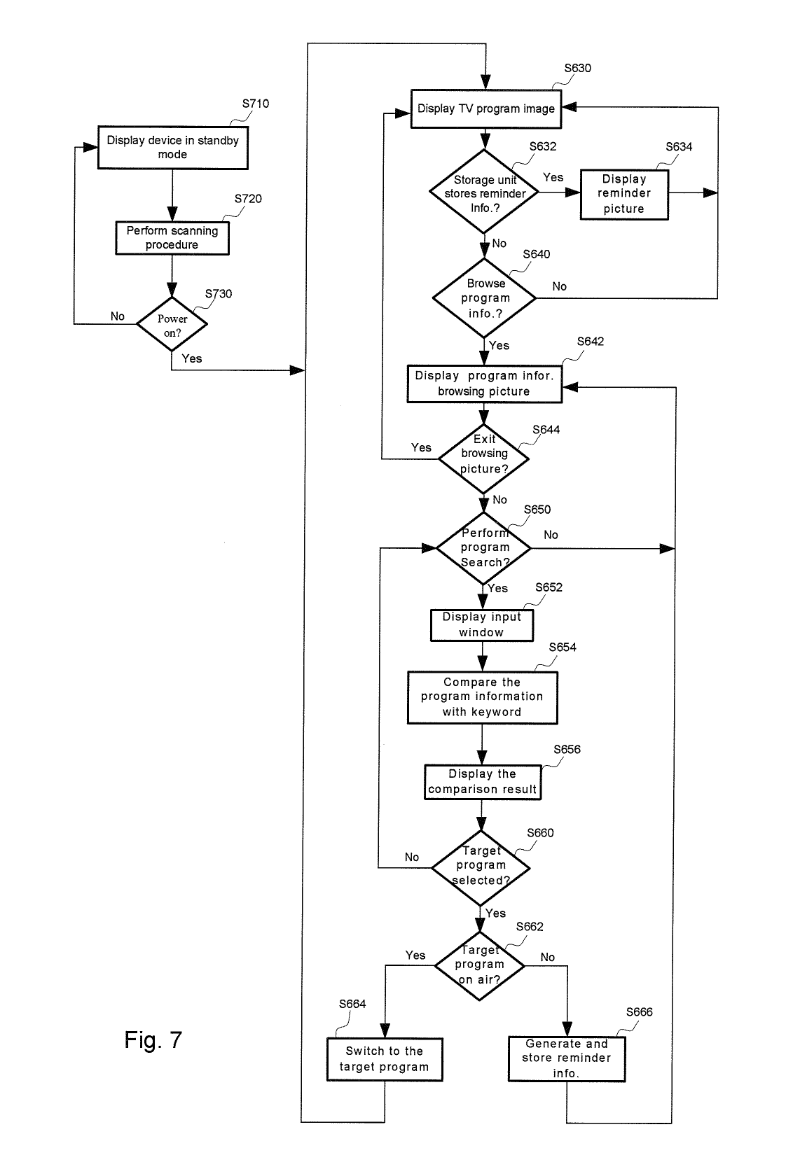

FIG. 6 illustrates a flow chart of the method for performing the scanning procedures after the display device enters the power-on mode, and FIG. 7 illustrates a flow chart of the method for performing the scanning procedures when the display device is under the standby mode according to another preferred embodiment of the claimed invention.

In FIG. 7, in the beginning, the display device is under the standby mode (S710). Then, a step of performing the scanning procedures (S720) under the standby mode is performed. Next, a step of determining whether to power on the display device is performed (S730). If no power-on signal is received by the display device, the procedure goes back to S710. If a power-on signal is received, the procedure goes to S630. Other steps are the same as those illustrated in FIG. 6, thus the description for those steps is omitted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit of a display device having a program search function, comprising:
a tuner, for receiving a TV signal;
a demodulator coupled to the tuner, for demodulating the TV signal to generate a demodulated signal;
a data analyzing unit coupled to the demodulator, for processing the demodulated signal to generate program information;
a storage unit coupled to the data analyzing unit, for storing the program information;
a receiving unit, for receiving an input data; and
a controller coupled to the tuner, the storage unit, and the receiving unit, for reading the program information from the storage unit and comparing the program information with the input data.

2. The control circuit of claim 1, wherein the receiving unit further receives a power-on signal, and the controller controls the display device to enter a power-on mode from a standby mode according to the power-on signal.

3. The control circuit of claim 2, wherein prior to the reception of the power-on signal by the receiving unit, the tuner receives the TV signal and the data analyzing unit processes the demodulated signal to generate the program information.

4. The control circuit of claim 1, further comprising:
a video decoder coupled to the demodulator, for decoding a video component of the demodulated signal to generate a decoded video signal; and
an image processing unit coupled to the video decoder and the controller, for processing the decoded video signal to generate a TV program image signal;
wherein the controller generates a program comparison result after comparing the program information and the input data, and the controller controls the image processing unit to display the program comparison result on a display unit.

5. The control circuit of claim 4, wherein when the receiving unit receives a program information browsing signal, the controller reads the program information from the storage unit and controls the image processing unit to output a program information browsing picture, so as to display the program information.

6. The control circuit of claim 4, wherein when a target program of the program comparison result is selected, the controller determines whether the target program is being broadcasted, and if the target program is being broadcasted, the controller controls the tuner to switch channel, so as to receive the target program.

7. A control circuit of a display device having a program search function, comprising:
a controller;
a first tuner coupled to the controller, for receiving a first TV signal;
a second tuner coupled to the controller, for receiving a second TV signal;
a demodulator coupled to the first tuner and the second tuner, for demodulating the first TV signal and the second TV signal to generate respectively a first demodulated signal and a second demodulated signal;
a data analyzing unit coupled to the demodulator, for processing the first demodulated signal to generate program information;
a storage unit coupled to the data analyzing unit, for storing the program information;
a video decoder coupled to the demodulator, for decoding a video component of the second demodulated signal to generate a decoded video signal; and
an image processing unit coupled to the video decoder and the controller, for processing the decoded video signal to generate a TV program image signal.

8. The control circuit of claim 7, further comprising:
a receiving unit coupled to the controller, for receiving an input data;
wherein the controller reads the program information from the storage unit and compares the program information with the input data to generate a program comparison result.

9. The control circuit of claim 8, wherein when the receiving unit receives a program information browsing signal, the controller reads the program information from the storage unit and controls the image processing unit to output a program information browsing picture, so as to display the program information.

10. The control circuit of claim 8, wherein when a target program of the program comparison result is selected, the controller determines whether the target program is being broadcasted, and if the target program is being broadcasted, the controller controls one of the first tuner and the second tuner to switch channel, so as to receive a TV signal corresponding to the target program.

11. A method for controlling a display device to receive program information of TV programs and select programs, comprising:
(a) receiving a TV signal;
(b) processing the TV signal to generate program information;
(c) storing the program information;
(d) receiving an input data;
(e) reading the program information and comparing the program information with the input data to generate a program comparison result; and
(f) displaying the program comparison result.

12. The method of claim 11, further comprising:
starting the display device to make the display device enter a power-on mode from a standby mode.

13. The method of claim 12, wherein the step (a) and the step (b) are completed under the standby mode.

14. The method of claim 11, further comprising:
reading the program information according to a program information browsing signal; and
displaying a program information browsing picture which comprises the program information.

15. The method of claim 11, further comprising:
determining whether a selected target program of the program comparison result is being broadcasted; and
receiving the TV signal corresponding to the target program if the target program is being broadcasted.

16. The method of claim 11, further comprising:
determining whether a selected target program of the program comparison result is being broadcasted; and
generating a reminder information and storing the reminder information if the target program is not being broadcasted.

17. The method of claim 16, further comprising:
determining whether the reminder information is stored; and
displaying a reminder picture according to the reminder information.

18. A method for controlling a display device to receive program information of TV programs and select programs, comprising:
(a) receiving a first TV signal with a first tuner;
(b) processing the first TV signal to generate program information;
(c) receiving a second TV signal with a second tuner;
(d) processing the second TV signal to generate a TV program image signal;
(e) storing the program information;
(f) receiving an input data; and
(g) reading the program information and comparing the program information with the input data.

19. The method of claim 18, further comprising:
starting the display device to make the display device enter a power-on mode from a standby mode.

20. The method of claim 19, wherein the step (a) and the step (b) are completed under the standby mode.

21. The method of claim 18, further comprising:
reading the program information according to a program information browsing signal; and
displaying a program information browsing picture which comprises the program information.

22. The method of claim 18, wherein a program comparison result is generated in the step (g), and the method further comprises:
displaying the program comparison result.

23. The method of claim 22, further comprising:
determining whether a selected target program of the program comparison result is being broadcasted; and
receiving the TV signal corresponding to the target program if the target program is being broadcasted.

24. The method of claim 22, further comprising:
determining whether a selected target program of the program comparison result is being broadcasted; and
generating a reminder information and storing the reminder information if the target program is not being broadcasted.

25. The method of claim 24, further comprising:
determining whether the reminder information is stored; and
displaying a reminder picture according to the reminder information.
